(19) United States
(12) Patent Application Publication
(10) Pub. No.: US 2013/0292515 A1
(43) Pub. Date: Nov. 7, 2013

(54) OVERPRESSURE DOOR FOR AN AIRCRAFT

(71) Applicant: AIRBUS OPERATIONS SAS, Toulouse (FR)

(72) Inventors: Yannick Sommerer, Cornebarrieu (FR); Alexandre Massol, Cugnaux (FR)

(73) Assignee: AIRBUS OPERATIONS SAS, Toulouse (FR)

(21) Appl. No.: 13/874,558

(22) Filed: May 1, 2013

(30) Foreign Application Priority Data
May 2, 2012 (FR) 12 53994

(51) Int. Cl. B64C 1/14

(52) U.S. Cl. CPC B64C 1/1461
USPC 244/129.5

(57) ABSTRACT

The overpressure door, of axial type, includes a hatch configured to pivot about an axis between a closed position and an open position and an aerodynamic appendage securely attached to the hatch. The aerodynamic appendage makes it possible to produce a deflection of the external flow in the open position of the hatch of the door.

### TECHNICAL FIELD

The present invention relates to an overpressure door, of axial type, for an aircraft, and an aircraft compartment and an aircraft provided with such a door.

More particularly, the present invention relates to an overpressure door which is installed on a partially or totally airtight compartment of the aircraft, subject to leaks of air under pressure. The overpressure doors are provided in areas of the aircraft or of engines of the aircraft, for which the air under pressure can be evacuated from a compartment by opening said overpressure doors. Such an overpressure door includes, in particular, a hatch which can pivot about an axis, between a closed position and an open position. Usually, the hatch (initially closed) opens when the differential pressure between its internal and external faces exceeds a given threshold.

An aspect of the present invention improves the aerodynamic efficiency of such an overpressure door.

### BACKGROUND OF THE INVENTION

It is known that the overpressure doors installed in areas of an aircraft, in particular of a transport airplane, which are subject to leaks of air under pressure, can be classified in two broad categories. These categories depend on the orientation of the hinge of the hatch relative to the external flow generated by the relative displacement of the aircraft in the air. A first category relates to the doors for which the rotation axis of the hatch is arranged substantially at right angles to the external flow. These doors are called “transversal”. The second category of overpressure doors, called “axial”, relates to the doors for which the rotation axis is substantially aligned with the external flow.

The pressure inside the area after opening the overpressure door depends on the pressure drop thereof. The internal pressure of the compartment during the dynamics of opening or after the overpressure door is fully open is often the design-deciding case for the cowls forming these areas. One of the effects of improving the aerodynamic efficiency of the overpressure door relates therefore to reducing the weight of the cowls, which is very important in the case of an aircraft.

The aerodynamic performance levels of the abovementioned two categories of overpressure door depend essentially on the ratio between the quantity of movement of the jet created by the evacuation of the air under pressure in the compartment and that of the external flow, that is to say, on the ratio ρ∪/ρₑₓₜ∪ₑₓₜ, in which ρ and ∪ are respectively the density and the speed of the air flowing through the opening of the door, and ρₑₓₜ and ∪ₑₓₜ are respectively the density and the speed of the external air flowing along the door.

For a given opening angle, the doors of “transversal” type exhibit low pressure drops for ratios of quantity of movement ρ∪/ρₑₓₜ∪ₑₓₜ that are low or relatively low, and higher pressure drops for higher ratios of quantity of movement. These overpressure doors are therefore advantageous for flight phases at high speed with low leak flow rates. However, the aerodynamic forces generated by the external flow generally limit the angle of opening of the “transversal” door, thus reducing its benefit with low movement quantity ratio.

The doors of “axial” type, for their part, exhibit lower pressure drops than the doors of “transversal” type for high movement quantity ratios ρ∪/ρₑₓₜ∪ₑₓₜ, and higher pressure drops than the doors of “transversal” type for lower movement quantity ratios. These overpressure doors are therefore beneficial for flight phases at reduced speed with significant leak flow rates. One of the drawbacks of these “axial” doors relates to their low stability in the open position. It is generally necessary to add a device preventing the flap motion of the door.

The opposing performance levels of these two categories of overpressure doors make it impossible to obtain an overpressure door which is efficient for all operating conditions. Furthermore, a door of “transversal” type creates an obstruction to the external flow which generates a suction effect. This suction effect becomes significant when the quantity of movement of the external flow is significant relative to the quantity of movement of the leak flowing through the opening of the door.

### BRIEF SUMMARY OF THE INVENTION

An aspect of the invention improves the aerodynamic efficiency of the overpressure doors installed on areas of an aircraft, in particular on an engine, in order to reduce the air pressure inside these areas and thus optimize the structural dimensioning of the parts of these areas.

The present invention relates to an overpressure door for an aircraft, of axial type, including a hatch which comprises an internal face and an external face and which can pivot about an axis, between a closed position and an open position.

To this end, according to an embodiment of the invention, said overpressure door of axial type is noteworthy in that it includes, at an upstream edge (relative to the direction of an external flow in the direction defined by said axis), an aerodynamic appendage which is securely attached to the internal face of the hatch at said upstream edge and which is arranged substantially transversally thereto so as:

to be retracted in the closed position of the hatch, relative to the outside; and

to produce a deflection of the external flow in the open position of the hatch.

Thus, as specified hereinbelow, an overpressure door is obtained which combines the advantages of the abovementioned two categories of overpressure door. In practice:

on the one hand, said overpressure door of axial type makes it possible to obtain the advantages of a standard axial door, and is therefore advantageous for flight phases at reduced speed of the aircraft with significant leak flow rates; and

on the other hand, said aerodynamic appendage makes it possible to produce a deflection of the external flow in the open position of the hatch and thus allow the effect of obstruction of the external flow characteristic of a door of transversal type and therefore to obtain the advantages of such a standard transversal door, such that the overpressure door according to the invention is thus advantageous for flight phases at high speed (of the aircraft) with low leak flow rates.

In addition, the aerodynamic appendage can be optimized such that the resultant aerodynamic forces:

increase the speed of opening of the door, in order to reduce the maximum pressure level inside the compartment; and

act as a stabilizer when the door is in the open position, in order to ensure that the latter does not flap.

Furthermore, unlike a “transversal” door for which the obstruction of the external flow is limited by the resultant of the aerodynamic forces on the door, the appendage makes it possible to ensure the desired obstruction of the external flow regardless of the movement quantities ratio.

An embodiment of the present invention therefore makes it possible to improve the aerodynamic efficiency of an overpressure door which is installed in an area of an aircraft, in particular on an engine, by making it possible to reduce the air pressure inside this area and thus optimize the structural dimensioning of the parts of this area. More particularly, an embodiment of the invention thus makes it possible, in particular, to reduce the weight of the cowl forming the area concerned.

Preferably, said aerodynamic appendage is fastened at right angles to the internal face of the hatch. However, it can also be fastened so as to present an angle other than a right angle. Furthermore, advantageously but not exclusively, it has a planar surface.

The effectiveness of this appendage depends on its shape. In practice, the greater the obstructed surface area in the open position of the hatch and, consequently the greater the deflection of the external flow, the lower the pressure drop of the door. The optimal shape of this appendage depends on the opening kinematics of the door. Thus, for an opening of the door by rotation about an axis, a curvilinear shape (with a free edge defined according to a circular arc) makes it possible to obtain the maximum obstructed surface area while allowing the hatch to open.

Moreover, the present invention also relates to:

a compartment for an aircraft, provided with at least one overpressure door as mentioned above, through which the air under pressure can be evacuated from said compartment when it is open; and

an engine for an aircraft, also provided with at least one such overpressure door.

The present invention also relates to an aircraft, in particular a transport airplane, which is equipped at least:

with an overpressure door; and/or

with a compartment; and/or

with an engine,

such as those mentioned above.

### BRIEF DESCRIPTION OF THE DRAWINGS

The figures of the appended drawing will give a good understanding as to how the invention can be produced. In these figures, identical references designate similar elements.

FIG. 1 schematically shows an overpressure door according to the invention, in an open position.

FIG. 2 schematically shows the overpressure door of FIG. 1, in a closed position, seen from below.

### DETAILED DESCRIPTION

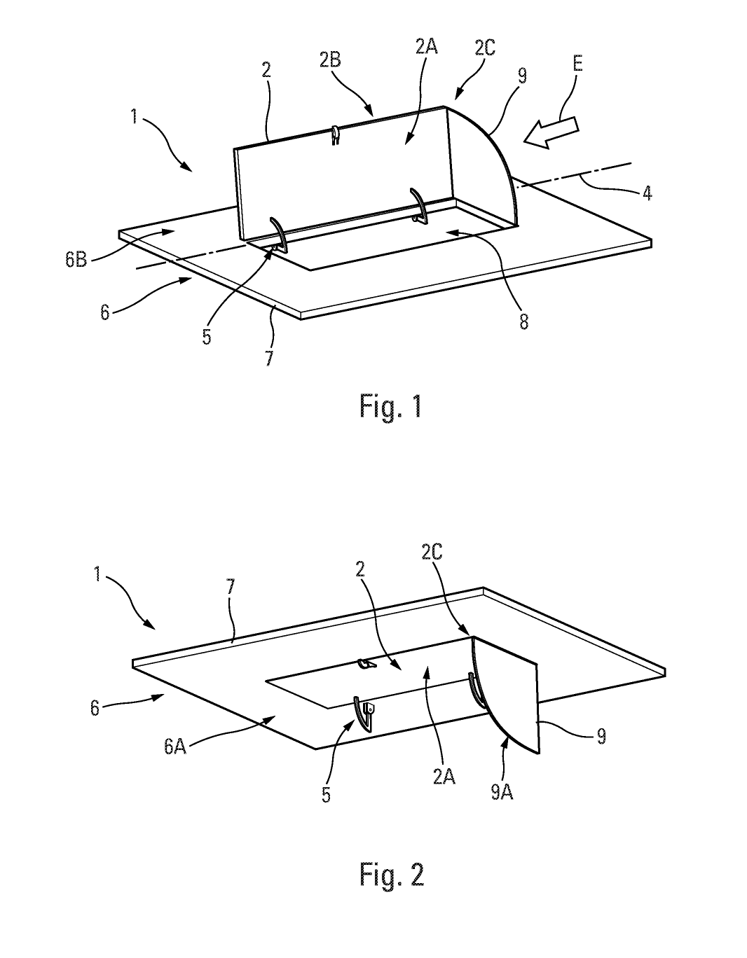

The present invention relates to an overpressure door 1 for an aircraft, of axial type, as schematically represented in FIGS. 1 and 2. This overpressure door 1 includes a hatch 2 which comprises an internal face 2A and an external face 2B and which can pivot about a rotation axis 4, via standard hinges 5, relative to a compartment 6 of which only a part 7 of the external wall has been represented. Said hatch 2 can pivot between a closed position (represented in FIG. 2) and an open position (represented in FIG. 1). Since said overpressure door 1 is of the axial type, the rotation axis 4 is aligned, to within a margin, with the external flow generated by the relative displacement of the aircraft in the air during a flight. Said external flow is illustrated by an arrow E in FIG. 1. The directions of the flow E and of the rotation axis 4 are therefore substantially parallel.

This overpressure door 1 is therefore installed on a compartment 6 of the aircraft or of an engine of the aircraft that is partially or totally airtight, subject to leaks of air under pressure, of which the inside is located by an arrow 6A and the outside by an arrow 6B.

Said overpressure door 1 also includes standard means (not specifically represented) which make it possible to open the hatch 2 when the pressure difference between the inside 6A and the outside 6B exceeds a predetermined value. These means are known and are not detailed more in this description.

Upon the appearance of a leak of air under pressure in the area of the aircraft on which the door 1 is installed, the air pressure inside 6A the area increases because of the injection of air. When the internal pressure reaches, relative to the external pressure, a given threshold, the hatch 2 of the door 1 (initially closed) pivots, thus freeing the opening 8 produced on the cowl 7 of the area concerned. The leakage air can then escape through the duly generated opening 8. The pressure increase in the area concerned is therefore reduced, and consequently the aerodynamic forces exerted on the parts forming this area are also reduced.

According to an embodiment of the invention, in order to improve its aerodynamic efficiency, said overpressure door 1 includes, at the upstream edge 2C relative to the direction of the external flow E in the direction defined by said axis 4, an aerodynamic appendage 9 which is securely attached to the internal face 2A of the hatch 2 at said upstream edge 2C and which is fastened transversally thereto so as:

to be retracted (relative to the outside 6B) in the closed position of the hatch, as represented in FIG. 2; and

to be situated in the external flow E, in the open position of the hatch 2, as represented in FIG. 1, so as to produce a deflection of the external flow.

Thus, an overpressure door 1 is obtained which combines the advantages of the two categories of overpressure door. In practice:

on the one hand, said overpressure door 1 of axial type makes it possible to obtain the advantages of a standard “axial” door, and is therefore advantageous for flight phases at reduced speed of the aircraft with a high leak flow rate; and

on the other hand, said aerodynamic appendage 9 makes it possible to produce a deflection of the external flow E in the open position of the hatch 2 and thus allow for the external flow obstruction effect characteristic of a “transversal” door and therefore to obtain the advantages of such a standard transversal door, such that the overpressure door 1 is then advantageous for flight phases at high speed of the aircraft with a low leak flow rate.

The aerodynamic performance levels of the abovementioned two categories of overpressure door depend essentially on the ratio between the quantity of movement of the jet created by the evacuation of the air under pressure in the compartment and that of the external flow, that is to say on the ratio ρ∪/ρₑₓₜ∪ₑₓₜ in which ρ and ∪ are respectively the density and the speed of the air flowing through the opening of the door, and ρₑₓₜ and ∪ₑₓₜ are respectively the density and the speed of the outside air flowing along the door.

Thus:

an axial door exhibits lower pressure drops than a transversal door for high movement quantity ratios ρ∪/ρₑₓₜ∪ₑₓₜ, and higher pressure drops for lower movement quantity ratios. Such an axial door is therefore advantageous for flight phases at reduced speed having high leak flow rates, as indicated above;

a transversal door exhibits low pressure drops for low or relatively low movement quantity ratios ρ∪/ρₑₓₜ∪ₑₓₜ and higher pressure drops for higher movement quantity ratios. Such a transversal door is therefore advantageous for flight phases at high speed with a low leak flow rate, as indicated above; and

the overpressure door 1 according to the invention makes it possible to combine the most efficient characteristics of these two categories of door.

An overpressure door 1 is thus obtained which is efficient for all operating conditions. Furthermore, it is possible to exploit the suction effect and therefore to have high aerodynamic performance levels.

The appendage 9 makes it possible to significantly improve the effectiveness of the axial door for low flow rate ratios. The increase in the efficiency of the door for higher leak flow rates is more modest. The appendage 9 also makes it possible, if it is optimized for these purposes:

to stabilize the door in the open position; and

to increase the speed of opening of the door, thus reducing the maximum pressure inside the compartment.

Said aerodynamic appendage 9 is fastened by any standard means to the internal face 2A of the hatch 2. Preferably, it is fastened at right angles to said internal face 2A. However, it can also be fastened at an angle other than a right angle.

Thus, in a particular embodiment of the invention, the aerodynamic appendage 9 is inclined (that is to say not at right angles) relative to the internal face 2A of the hatch 2 (with, for example, an angle of 80° between the hatch 2 and the appendage 9). The advantage of this embodiment is that the aerodynamic force undergone by the appendage 9 (under the action of the external flow E) also provides a component (at right angles to the hatch 2) which makes it possible to increase the speed of opening of the hatch 2 and which ensures the stability of the hatch 2 in the open position.

Thus, in this case:

said aerodynamic appendage 9 is arranged in such a way as to ensure the stability of the door 1 in the open position, by exerting an aerodynamic force that is not parallel to the rotation axis 4 of the door 1; and

said aerodynamic appendage 9 is arranged in such a way as to increase the speed of opening of the door, by exerting an aerodynamic force with a component of the same sign as the direction of opening of the door.

Furthermore, it has, preferably but not exclusively, a planar surface, as represented in FIGS. 1 and 2. This appendage 9 is defined, preferably empirically, so as to optimize the overpressure door 1 according to one criterion or a plurality of criteria combined, and in particular at least one of the following criteria: the aerodynamic stability of the door in the open position, the aerodynamic efficiency, the acceleration of the door opening dynamics, the weight, and an external aerodynamic effect.

The effectiveness of the appendage 9 depends on its shape. In practice, the greater the obstructed surface area and, consequently the greater the deflection of the flow, the lower the pressure drop of the door 1.

Thus, for an opening of the hatch 2 in rotation about an axis 4, as considered in the present invention, a curvilinear shape (with a free edge defined according to a circular arc 9A) makes it possible to obtain the maximum obstructed surface area while allowing the opening of the hatch 2.

Obviously, other shapes are possible for the aerodynamic appendage 9 and in particular a triangular shape.

An embodiment of the present invention therefore provides for the addition of an aerodynamic appendage 9 to an “axial” door 1, in order to combine the advantages of the two categories of overpressure doors (“axial” and “transversal”) and thus obtain high aerodynamic performance levels, regardless of the operating conditions.

It thus makes it possible to improve the aerodynamic efficiency of an overpressure door 1 which is installed on an area of an aircraft, in particular on an engine, by making it possible to reduce the air pressure inside this area and thus optimize the structural dimensioning of the parts of this area. More particularly, an embodiment of the invention thus makes it possible in particular to reduce the weight of the cowl forming the area concerned.

It will be noted that, for a turbomachine of an aircraft, such overpressure doors 1 can in particular be installed:

on compartments, and in particular the fan compartment;

on the nacelle; and

on the engine pylon.

1. An aircraft comprising:
at least one overpressure door, of axial type, including a hatch comprising an internal face and an external face and configured to pivot about an axis, between a closed position and an open position,
wherein said overpressure door comprises, at an upstream edge relative to the direction of an external flow in the direction defined by said axis, an aerodynamic appendage securely attached to the internal face of the hatch at said upstream edge and arranged transversely thereto so as:
to be retracted in the closed position of the hatch, relative to the outside; and
to produce a deflection of the external flow in the open position of the hatch.

2. The aircraft as claimed in claim 1, wherein said aerodynamic appendage is fastened at right angles to the internal face of the hatch.

3. The aircraft as claimed in claim 1, wherein said aerodynamic appendage is inclined relative to the internal face of the hatch.

4. The aircraft as claimed in claim 1, wherein said aerodynamic appendage has a planar surface.

5. The aircraft as claimed in claim 1, wherein said aerodynamic appendage has a shape adapted to the opening kinetics of the hatch.

6. The aircraft as claimed in claim 1, wherein said aerodynamic appendage has a free edge defined according to a circular arc.

7. The aircraft as claimed in claim 1, wherein said overpressure door forms part of a compartment of the aircraft, provided with at least one overpressure door, through which the air under pressure can be evacuated from said compartment when it is open.

8. The aircraft as claimed in claim 1, wherein said overpressure door forms part of an engine of the aircraft provided with at least one overpressure door.
